(19) United States
(12) Patent Application Publication
(10) Pub. No.: US 2026/0187575 A1
(43) Pub. Date: Jul. 2, 2026

(54) DOMAIN MODEL IN ENTERPRISE APPLICATION DEVELOPED BY CODELESS PLATFORM

(71) Applicant: NB Ventures, Inc., DBA GEP, Clark, NJ (US)

(72) Inventors: Subhash Makhija, Westfield, NJ (US); Huzaifa Shabbir Matawala, Princeton, NJ (US); Nithin Maruthi Prasad, Avenel, NJ (US); Shivendra Singh Malik, Vasco-da-Gama (IN)

(21) Appl. No.: 19/006,815

(22) Filed: Dec. 31, 2024

(51) Int. Cl. G06Q 10/067; G06Q 10/087

(52) U.S. Cl. CPC G06Q 10/067; G06Q 10/087

(57) ABSTRACT

The present invention provides a system and method for managing one or more dynamically changing domain model of one or more applications developed by codeless platform. The invention includes API configured to adjust to dynamic changes in the domain model based on modification of the one or more applications.

### BACKGROUND

### 1. Technical Field

The present invention relates generally to application developed by codeless platform. More particularly, the invention relates to domain model for an enterprise application developed by a codeless platform.

### 2. Description of the Prior Art

Enterprise applications have a rigid data structure driving the functions of the application. The applications have undergone significant changes with increasing complexity over time. Due to dynamically changing landscape of desired functionalities in the application, the technical problems associated with structuring the application have become extremely challenging.

### APP

Any operational requirements of an organization triggers changes in the underlying code of the enterprise application. However, the basic structure of the applications is rigid, and it requires a developer to modify the structure. Such modification, to introduce a new feature comes with its own technical challenges as modifying the code may break another function of the enterprise application. Moreover, a significant amount of time is required to carry out changes or modifications to the code structure. Further, any change requires a skilled developer to make changes to the complex enterprise application scenarios at system backend which may be extremely tedious considering the developer may understand only certain sections of the entire enterprise application. Moreover, the front-end requirements of the end user may not be understood to a developer in case the user requests certain changes to the flow and structure of one or more functions/sub-applications of the enterprise application. Every end user has a different operational requirement depending on industry verticals and variations based on region of operation. It is impractical to accommodate such requirements through the existing enterprise applications.

Codeless platforms empower different types of users to manage new or existing attributes, modify enterprise application functional processes, configure rules and workflow. However, in codeless platform attributes are dynamic and driven by random modifications in the process flows, so defining prioritization rules for enterprise application task management process execution on different criterions becomes challenging and complex. Moreover, the applications developed through codeless platform may have been developed by reusable codes, but these codes are restricted in their functionality due to underlining architecture and thereby create technical issues in data processing for certain functionality in the enterprise application, particularly when the functionality is dealing with dynamic data and changing flows. In such a scenario, the system is unable to make sense of the change in the flow and identify associated task modifications which disrupts the entire execution cycle of the enterprise application functions.

Codeless platform enabling development or modification of applications in real time creates additional challenges due to conflicting nature of the applications. Whether it is structuring of sub applications of the enterprise application, or automation of creation of application functions, or modernization of legacy systems, the conflicting objects creates scenarios that are unpredictable, and they can't be determined or forecasted with the existing solutions. Moreover, certain events and processes depend on the way data is stored in the system, any random changes in the associated function increases the risk.

In view of the above problems, there is a need for a data processing system and method that enables communication between layers of a codeless platform to overcome the problems associated with the prior arts.

### SUMMARY OF INVENTION

According to an embodiment, the present invention provides a system and method for managing one or more dynamically chaining domain model of one or more enterprise applications developed by a codeless platform. The method includes receiving one or more attributes of the application configured to modify one or more application, identifying characteristic of the one or more attributes associated with the modified one or more application, creating at least one domain model based on the attribute of the application, characteristics of the attributes, and one or more data validation rules; and invoking by a bot, an API (Application Programming Interface) generating data script configured to auto-generate one or more API for integrating with the one or more domain model wherein the one or more API is generated based on behavior of the attributes on an electronic user interface of the application, the one or more data validation rules and a data pattern associated with operation of the one or more applications, wherein API is configured to adjust to dynamic changes in the domain model based on the modification of the one or more application developed by the codeless platform.

In an embodiment, the data pattern is obtained from an application Knowledge database configured to store data about dynamic changes in the attributes and related functions of the application.

In another embodiment of the invention, the characteristic of the one or more attributes includes mandatory non-mandatory fields, data type of the attribute, length of the attribute, default value, validations, flags to send data to tertiary systems as audit log, reports, availability of the attribute for components like bulk templates, and define annotations of the attribute.

In an embodiment, the processor is configured to generate one or more data models based on the application knowledge database wherein the knowledge database stores real-time application usage data for recommending the attribute.

In another embodiment the invention includes processing a historical dataset characteristic data from the knowledge database to predict data attribute characteristic for recommending the attribute based on a dynamic processing logic.

In yet another embodiment, the dynamic processing logic integrates deep learning, predictive analysis, data extraction, impact analysis, configuration pattern generation and bots for processing the dataset to recommend the attribute.

In an embodiment, a code generated by the bot triggers a rule engine to involve assessment of the attribute based on an attribute rule data script.

In an embodiment, the invention provides a platform architecture configured to manage one or more dynamically changing domain model of one or more enterprise applications including one or more SCM (Supply Chain Management) applications developed by a codeless platform. The architecture includes a plurality of configurable components interacting with each other in a layered architecture, a customization layer configured to customize the one or more SCM application based on at least one modified application object and at least one operation to be executed, an application layer interacting with the customization layer through one or more configurable components of the plurality of configurable components wherein the application layer is configured to organize at least one application service of the one or more SCM application with at least one modified application object, a shared framework layer communicating with the application layer through one or more configurable components of the plurality of configurable components wherein the shared framework layer is configured to fetch shared data objects for enabling execution of the at least one application service. The architecture includes a foundation layer configured for infrastructure development through one or more configurable components of the plurality of configurable components wherein the foundation layer communicates with the shared framework layer for enabling fetching of shared data objects, a data layer communicating with the foundation layer through one or more configurable components of the plurality of configurable components wherein the data layer is configured to manage database native queries mapped to the at least one operation and a process orchestrator configured to enable interaction of the plurality of configurable components in the layered architecture for executing the at least one operation and develop the one or more SCM application with the at least one modified application object.

In an embodiment, the domain models include one or more annotations configured for enabling a domain model bot to identify characteristic of the dynamically changing domain model.

In another embodiment, the domain model includes one or more application entities with their relationship to other entities represented by association wherein the one or more annotations connected to the domain model enables identification of means by which the domain model is to be operated.

In an advantageous aspect, domain model is a building block of the codeless platform. It is a core layer of the architecture used as a communication channel between components across layers. Domain Model is a representation of enterprise platform independent of the way data is stored in databases. Domain Model enforces standardization w.r.t schema, nomenclature, validations across supply chain applications. The domain model describes the domain types for an enterprise with their constraints. Using domain data types instead of base data types ensures consistency across an enterprise and allows reuse of common data type definitions for greater efficiency.

In another advantageous aspect, the present invention utilizes Machine Learning algorithms, prediction data models, artificial intelligence and LLM (large language models) for execution of one or more SCM application operations.

In yet another advantageous aspect, the Low code component enables dynamic addition of fields on the interface. The domain model helps low code system by making it based on field which is searchable, auditable and provides data access control, unlike rigid data structure driven applications.

### BRIEF DESCRIPTION OF THE DRAWINGS

The disclosure will be better understood and when consideration is given to the drawings and the detailed description which follows. Such description makes reference to the annexed drawings wherein:

FIG. 1 is a data processing system for managing one or more dynamically changing domain model of one or more enterprise applications developed by a codeless platform in accordance with an embodiment of the invention.

FIG. 1A is a block diagram of domain model AI agent for data processing in accordance with an embodiment of the invention.

FIG. 2 is a flow chart depicting a method of managing one or more dynamically changing domain model of one or more enterprise applications developed by codeless platform in accordance with an embodiment of the invention.

FIG. 3 is a user interface of the enterprise application depicting properties of an application object or document in accordance with an example embodiment of the invention.

FIG. 3A is a user interface of the enterprise application depicting an elaborate version of the properties of an application object or document in accordance with an example embodiment of the invention.

FIG. 4 is a user interface of the enterprise application depicting data validation of an application object or document in accordance with an example embodiment of the invention.

FIG. 4A, is a user interface of the enterprise application depicting data services enablement of an application object or document in accordance with an example embodiment of the invention.

FIG. 5 is a user interface of the enterprise application depicting automation enablement of an application object or document in accordance with an example embodiment of the invention.

FIG. 5A is a user interface of the enterprise application depicting data annotations of an application object or document in accordance with an example embodiment of the invention.

FIG. 6 is a block diagram depicting types of associations of entities with operational values like order and supplier is shown in accordance with an example embodiment of the invention.

FIG. 7 is a flow diagram of vulnerability determination in accordance with an embodiment of the invention.

FIG. 8 shows a Widget builder platform as a field of field UI builder system with multiple modules and flows in accordance with an embodiment of the present invention.

FIG. 8A shows plugins through messaging bus pattern in accordance with an embodiment of the present invention.

FIG. 9 shows the widget builder platform with multiple modules and process flow for adding a field on an application UI in accordance with an embodiment of the present invention.

### DETAILED DESCRIPTION

Described herein are the various embodiments of the present invention, which includes systems and methods for managing one or more dynamically changing domain model of one or more enterprise applications developed by a codeless platform.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,”“connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “customization layer,” “application layer,” “foundation layer” or “data layer,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to codeless development platform, system and method for managing one or more dynamically changing domain model of one or more enterprise applications including supply chain management application.

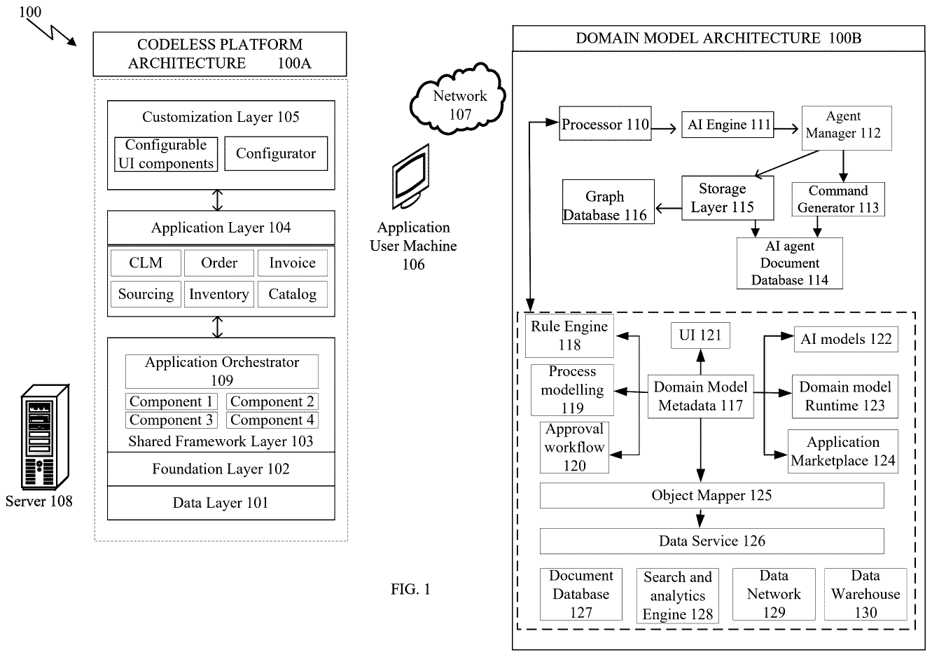

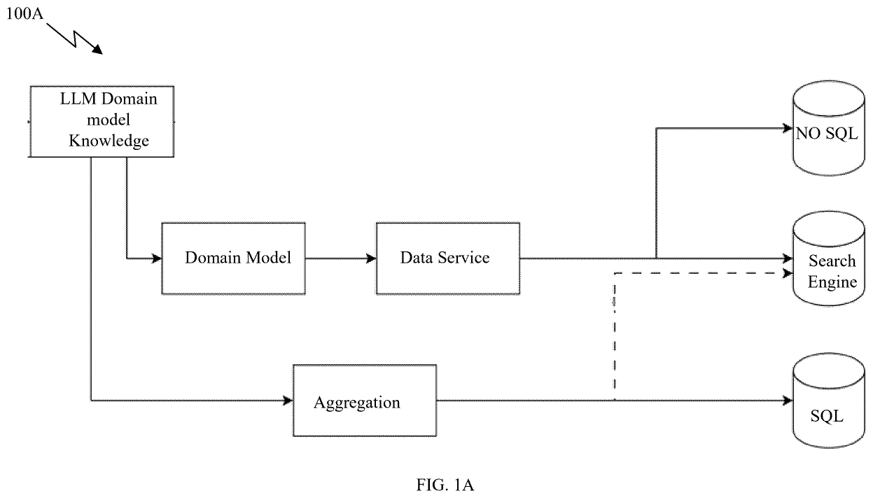

Referring to FIG. 1, an architecture diagram of a data processing system 100 for managing one or more dynamically chaining domain model of one or more enterprise applications developed by a codeless platform is provided in accordance with an embodiment of the present invention. The architecture of the data processing system includes a codeless platform architecture 100A and a domain model architecture 100B.

The system for managing domain models captures operational information and rules. The technical details of the system for storing the information are mapped to a Data Model. The Data model is optimized for data storage and retrieval irrespective of data model types, Hierarchical model, Network model, Entity-relationship model, Relational model. The domain Model has a wrapper to connect to various database types. The system includes Object Mapper which is responsible for converting domain model to data model as per schema defined. CRUD Operations exposed by Domain Model has operational rules validations, Mandatory check, Defaulting etc. APIs exposed by domain model are mapped to Form Designer and CRUD operations for transaction.

The codeless platform architecture 100A of the system 100 is a layered architecture 100A configured to process complex operations of one or more applications including supply chain management (SCM) applications using configurable components of each layer of the architecture 100A. The domain model enables structuring of the layered architecture for faster processing of complex operations as the workflow may be reorganized dynamically using the configurable components. The layered architecture includes a data layer 101, a foundation layer 102, a shared framework layer 103, an application layer 104 and a customization layer 105. Each layer of the codeless platform architecture 100A includes a plurality of configurable components interacting with each other to execute at least one operation of the SCM enterprise application. It shall be apparent to a person skilled in the art that while FIG. 1 provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine, and a platform developer user through its computing device triggers the shared framework layer 103, the foundation layer 102 and the data layer 101 to structure the platform for enabling codeless development of SCM applications. Since, both client domain side user and developer domain side user have the ability to modify the application or application objects, the interaction with each of the layers of the architecture creates challenges for acceptance of the modification to the application objects, particularly in case of conflict or vulnerability determination.

In an embodiment the present invention provides one or more SCM enterprise application with an end user application UI and a citizen developer user application UI for structuring the interface to carry out the required operations. Further, the domain model based layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the reconfiguration of the system to manage the related changes in the task is cumbersome. Moreover, in case the changes are conflicting with the changes done by a client domain user, the system needs to understand the context of the changes and readjust the process flows, application objects on an interface of the application after determining vulnerabilities associated with the changes. The domain model associated with the architecture changes dynamically and requires data processing techniques to efficiently address the issues.

In one embodiment, the codeless platform architecture 100A provides the cloud agnostic data layer 101 as a bottom layer of the architecture. This layer provides a set of micro-services that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP—online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

In an embodiment the platform architecture provides 100A the foundation layer 102 on top of the data layer 101 of the architecture 100A. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permission) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In a related embodiment, the plurality of configurable components includes one or more shared framework configurable components including but not limited to license manager, E-sign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, the architecture 100A provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer domain user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of application orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, the architecture 100A provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with a application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence (AI) based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by server processor. The electronic circuity has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low-speed interface connecting to low-speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high-speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system of the present invention includes a front-end web server communicatively coupled to at least one database server, where the front-end web server is configured to process the dataset characteristic data based on one or more data models and applying an AI based dynamic processing logic to automate execution of the task in the application developed by the codeless development actions through the domain model structure.

In an embodiment, the platform architecture 100A of the invention includes an application orchestrator 109 configured for enabling interaction of the plurality of configurable components in the layered architecture 100 for executing at least one SCM application operation and development of the one or more SCM application. The application orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based application orchestration engine configured for interacting with a plurality of configurable components in the platform architecture for executing SCM operations.

In an embodiment, application orchestrator 109 includes a service connector for integrating different services with the one or more SCM application and interaction with one or more configurable components based on the domain model structure. Further, Configurator User interface (UI) services are used to include third party networks managed by domain providers.

In a related aspect, the Artificial intelligence (AI) based orchestrator engine enables execution of SCM operation by at least one data model wherein the AI engine 111 transfers processed data to the UI for visibility, exposes SCM operations through API and assist the manager for application orchestration and control.

In an exemplary embodiment, the AI engine 111 employs machine learning techniques that learn patterns and generate insights from the data for enabling the process orchestrator to automate operations. Further, the AI engine 111 with ML employs deep learning that utilizes artificial neural networks to mimic biological neural network in human brains. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for operating one or more SCM enterprise application.

In an embodiment, the system 100 of the present invention includes a workflow engine that enables monitoring of workflow across the SCM applications. The workflow engine with the application orchestrator 109 enables the platform architecture to create multiple application workflows based on the task to be executed.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an embodiment, the domain model architecture 100B includes a processor 110 coupled to an AI engine 111 configured for executing one or more tasks. The processor is configured for receiving one or more attributes of the application configured to modify one or more application, identifying characteristic of the one or more attributes associated with the modified one or more application, and creating at least one domain model based on the attribute of the application, characteristics of the attributes, and one or more data validation rules. The processor 110 serves as the bridge between the different users and the backend components of the domain model architecture. The Domain model architecture 100B includes an AI agent manager 112, a command generator 113 and a storage layer 114. The AI agent manager 112 is configured to trigger command generator 113 for generating a command code in response to modification of the application objects and storing the command in a document database 114. The architecture 100B includes AI agents including domain model (DM) AI agent, application function AI agent, and execution agent. Architecture includes a storage layer 115 configured for storing one or more AI agents and domain specific AI tools for managing dynamically changing domain model. The architecture 100B also includes a graph database 116 configured for providing information based on data relationship script wherein a hierarchical structure of the graphical database enables application development optimization based on identified relationship between the at least one modified application object and the one or more internal application object.

In another embodiment, the domain model architecture 100B includes domain model metadata 117, rule engine 118, process modelling and notation 119, approval workflow engine 120, UI 121 for accepting changes from a user and displaying the modifications to the application by interacting with the domain model metadata 117. The architecture 100B further includes AI (Artificial intelligence) models or LLM models triggering various responses through the system based on the domain model structure, domain model runtime 123, application marketplace 124, an object mapper 125, data service 126, document database 127, search and analytics engine 128, a data network 129 and a data warehouse 130. The Citizen Developers will configure the metadata of all building blocks, and all the data structure metadata will be coming from the domain model (e.g. Views, Plugins Binding, process modelling and notations data structures, Rule Engine data structures etc.).

In a related embodiment, Domain model Runtime 123 is API/operation that does the execution of CRUD [create, read, update, delete operations] on the domain model entity that was created in design time. What this means is, once the domain model is created, it needs to be updated/deleted/read when a document is going through its execution cycle. The application marketplace 124 stores the domain model created in the application to keep record in design time. The Object Mapper 125 is responsible for converting domain model to data model as per schema defined. The Data service 126 is used by the domain model runtime API to interact with any database. The Document database 127 stores all the document/app related transactions. The search and analytics engine 128 is configured to search the documents in the database (DB) and if needed performs analytics like aggregations [for example, on status cards in the document workbench, the system shows how many documents are there per status]. Further, once the document is executed by the runtime domain model, it is sent to data network 129 to identify where does it fits in the entire user journey. Like if an invoice is created, it is linked to the original order and an order to its requisition and so forth. The data warehouse 130 is the storage facility of our reporting system. Once any document CRUD operations are doing using domain model runtime API, the events are sent to data warehouse for the reporting system to update.

The domain model consists of entities with their relationships to other entities represented by associations. The metadata provides annotations to the domain model to explain how it is to be used. The domain model architecture enables developers and citizen developers to carry out a common language and fundamental structure of the application throughout any related activities such as discovery, development, showcasing, and maintenance. Further, the architecture encourages a highly collaborative and visual experience that can involve developers, subject matter experts, stakeholders, and decision makers, all working towards a better shared understanding. The system helps in gaining control and valuable insights at every step, even for the most complex applications, with the help of analytics, security policies, audits, annotations, and more. Further, the system enables non-technical users to create applications and enable them with latest technologies like AI just by configuration.

The processor 110 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a /er/ demand planner and convert them for submission to the processor. In addition, an external interface may be provided in communication with Processor 110, so as to enable near area communication of device with other devices. External interface may provide, for example, for wired communication in some implementations, or for wireless communication in other implementations, and multiple interfaces may also be used.

In an example embodiment, the tools for executing AI agent functions of modifying application objects by executing a deterministic flow of logic include interface library-based functions. For eg: Python functions could wrap multiple utilities in them such as machine learning (ML) model and LLM executors etc. The tools also include application programming interface (API) executors that executes API calls when requested. The system includes a set of API executors of all major API's form part of the toolbox. Further, the tools also include databases and data source connector tools. The tool includes machine learning based data models or large language models (LLM) with access to a bundle of tools to achieve the objectives. These agents are driven by prompt(s) configured to enable process orchestration and tool selection.

In an embodiment, the domain model architecture 100B includes the storage layer 114 configured to keep track of all the required data or information generated during data processing. This component of architecture 100B, is configured for storing information such as memory objects, the selected tools, the state of execution and the error messages among others. Further, the domain model acts as a communication means between different layers to enable data processing.

In an exemplary embodiment, the memory or storage layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an exemplary embodiment, the domain model-based system of the invention includes a graph-based database design structured to optimize application development and deployment on the codeless platform. The structure is hierarchical, promoting modularity and reuse of components. The levels of abstraction include domains, application group, and task module. The domains represent various environments, in which the applications are structured or created. The most granular level is the developer domain, then Industry, client and Production as we move upwards in the hierarchy. The application group is logical grouping of modules where each application houses multiple modules tailored to specific tasks or functionalities. The task module is deployment unit within the application where a module encapsulated multiple components including Localization configured to handle language translations and region-specific content, CDS as a service facilitating HTTP calls, Plugins as extensions or add-ons enhancing the module's capabilities, Widgets representing individual pages or user interface components and Domain Model that defines the data structures and operational logic.

In an exemplary embodiment, the domain model of an application developed by a codeless platform includes a task of identifying characteristic of the one or more attributes associated with the modified one or more application. The system includes an artificial intelligence (AI) bot configured for creating an API generating data script configured for auto-generating one or more API to integrate with the domain model.

In an embodiment, the application object includes front end or backend object components of the application including data object, meta data, application workflow components, and UI components associated with execution of operations in a supply chain application. The back-end object components include domain model, data validation rules, application process model, State Machine, approval rule engine, and code snippet in microservice. The front-end object components include front rule User Interface (UI) behavior, form elements, labels, fields, sections, and buttons based on state machine.

In an embodiment, the bot deploys the front end and back-end object components of the application into a single node pattern with an application data structure and an augmented application data structure wherein the augmented application data structure shares one or more resources with the application data structure and enables modification of the applications.

In an embodiment, the domain model-based structure enables fetching information from a graph database. The system includes database agnostic storage of attributes and one or more application object data. The data object of the application is stored as a graph structure enabling identification and association of data object relationships.

In another embodiment, the domain model-based system supports application microservice such as custom logic, code generation, document creation, and API support authentication. Further, the domain model enables fetching of data regardless of how it is stored in the database, where the system includes data library having source data, destination data, versioning data, entity code and an identifier code generated by the processor.

Referring to FIG. 1A, a domain model LLM/AI agent functional block diagram 400 is provided in accordance with an example embodiment of the invention. The Platform-Owned Domain Model AI Agent (DM Agent) is a component designed to manage and interact with the data architecture of a codeless platform, especially within contexts like Source to Pay solutions. The architecture leverages the foundational structure of data models across various applications within the platform, such as invoicing, sourcing, and purchasing, to fetch, create, update, and aggregate data efficiently across diverse storage systems. The core functionalities of the LLM based architecture are executed as the Domain model LLM is adept at performing CRUD (Create, Read, Update, Delete) operations across multiple data storage systems, including No SQL database for document-based data, search engine for search and quick retrieval, and a SQL Server analytics database for aggregated insights. It also includes intelligent Data Aggregation by understanding the limitations of each storage system, such as the inability to perform joins in No SQL database or the delay in data refresh in the SQL Server. The domain model LLM aggregates and synthesizes data from these sources to provide comprehensive insights. Further, the domain model LLM provides real-time and historical data handling by seamlessly handling both real-time operational data from No SQL and search engine, and historical or aggregated data from the SQL Server, ensuring users have access to the most relevant and updated information.

In an embodiment, the operation workflow of the domain model LLM includes request analysis where upon receiving a data request, the LLM analyzes the requirements to determine the exact nature of the task needed, whether it's real-time rule modification data for operational decisions or supply chain functions for strategic insights. It also includes source Selection and Query Preparation where the LLM selects the appropriate source(s) based on the request's nature and prepares optimized queries for each source, considering the unique capabilities and limitations of document database and SQL Server. The Large language model (LLM) then executes the queries, retrieves the rules, and performs intelligent aggregation and normalization to compile a unified actionable script that meets the request's requirements. The actionable script is then formatted into a structured response, ready to be consumed by other components or LLM within the platform. Finally, the prepared rule is delivered to the requester, utilizing the platform's communication protocols, which may include direct API responses or inter-agent messaging through a Communication Broker.

In an advantageous aspect, the domain model LLM provides contextual awareness. The LLM maintains a rich contextual understanding of the domain models it manages, enabling it to make informed decisions about data handling and application integration. It also provides Security and Compliance as given its access to potentially sensitive data across multiple applications and storage systems, the LLM is designed with robust security measures and compliance checks to protect data integrity and privacy. Further, the LLM provides performance Optimization by employing advanced algorithms and caching strategies to optimize query performance and response times, ensuring that interactions are both fast and efficient.

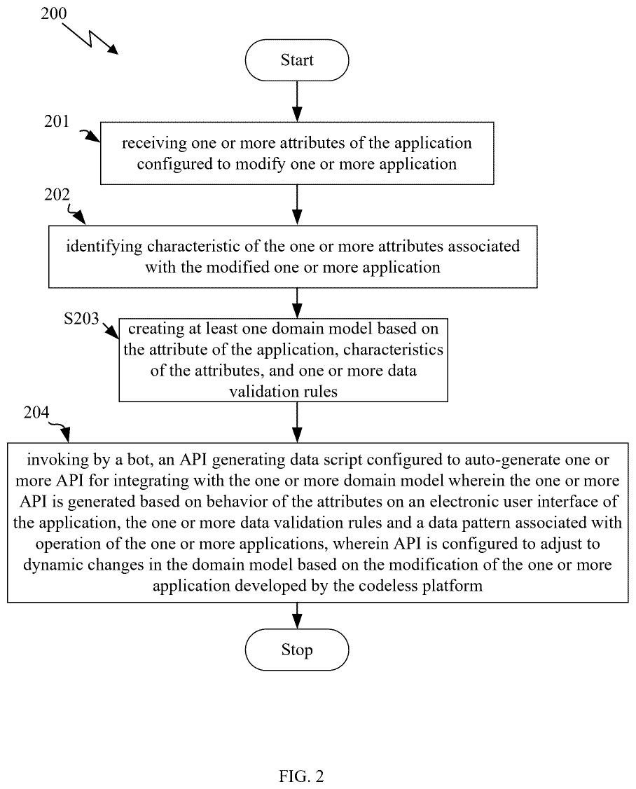

Referring to FIG. 2, a flowchart 200 depicting the method of managing dynamically changing domain model of one or more enterprise applications developed by a codeless platform is provided in accordance with an embodiment of the invention. The method includes the step of 201, receiving one or more attributes of the application configured to modify one or more application. In step 202, identifying characteristic of the one or more attributes associated with the modified one or more application. In step 203, creating at least one domain model based on the attribute of the application, characteristics of the attributes, and one or more data validation rules, and in step 204 invoking by a bot, an API generating data script configured to auto-generate one or more API for integrating with the one or more domain model wherein the one or more API is generated based on behavior of the attributes on an electronic user interface of the application, the one or more data validation rules and a data pattern associated with operation of the one or more applications, wherein API is configured to adjust to dynamic changes in the domain model based on the modification of the one or more application developed by the codeless platform.

In an embodiment, the method of the invention includes triggering by the AI (artificial intelligence) bot, a domain model having one or more application entities with their relationship to other entities represented by associations wherein one or more annotations connected to the domain model enables identification of means by which the domain model is to be operated.

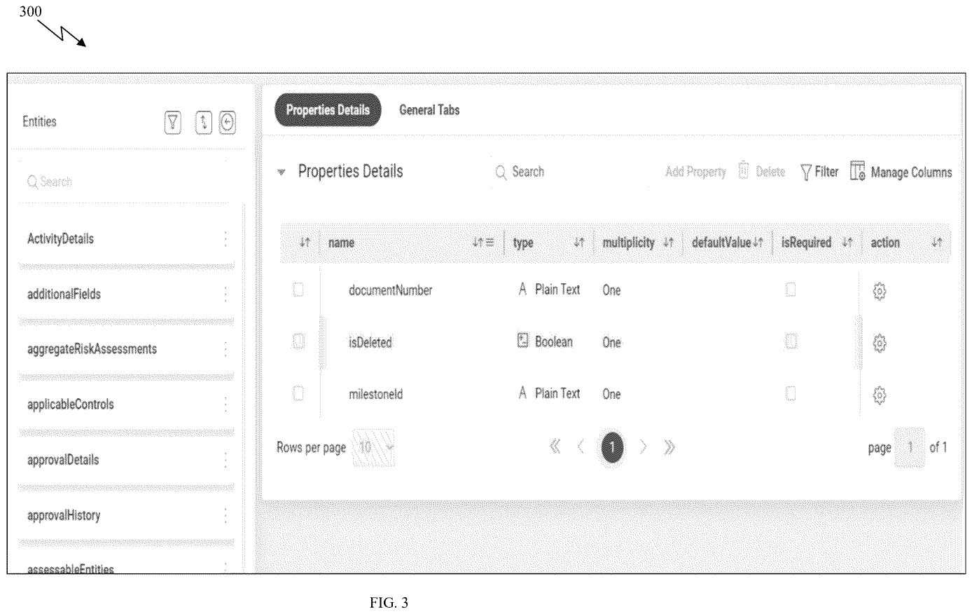

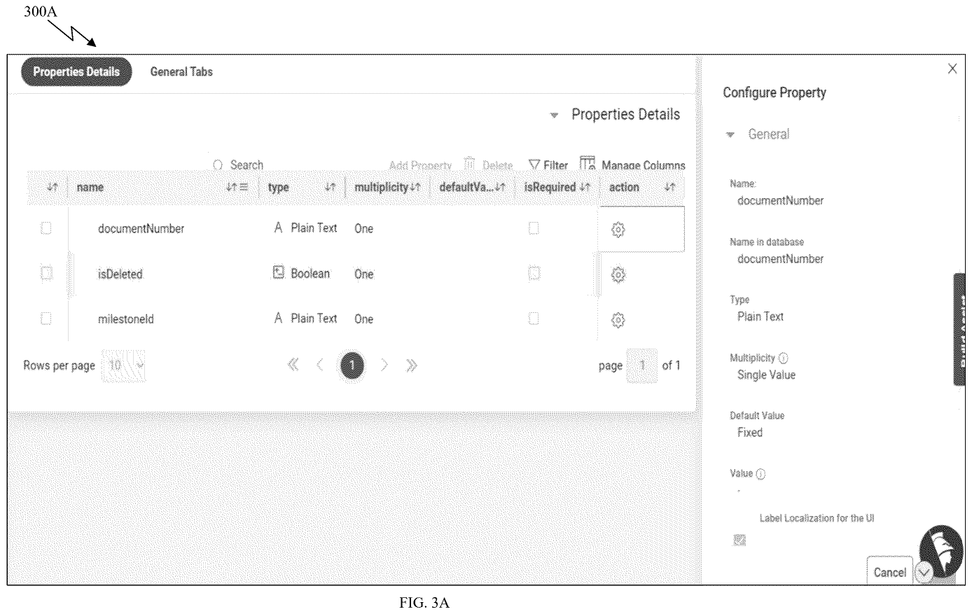

Referring to FIGS. 3, 3A, user interface (300, 300A) of the enterprise application providing properties of an application object or document is shown in accordance with an example embodiment of the invention. This user interface provides a view of the domain model entity. This shows that there are properties associated with this entity and what are the types of each of the properties. This also shows the configuration details of each property on the right side. The configurations are divided into multiple sections. The first section in this picture shows the general configs like name, type, default value [if any] and if you need any AI based localization on the property.

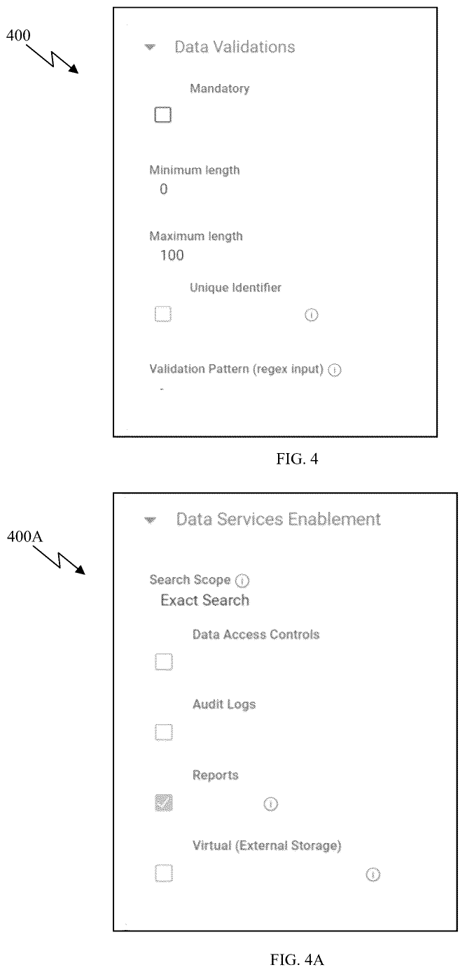

Referring to FIGS. 4, 4A, user interface (400, 400A) of the enterprise application depicting data validation and data services of an application object or document is shown in accordance with an example embodiment of the invention. This shows if we want to add any data validations on the property itself. Data validations include making sure that the field is mandatory or not, the min/max length of that field/property and if we want to apply any regex pattern on the property [regex meaning that if we want to apply any logic on field like if the value goes beyond 1000 then show validation or if the user is trying to enter a wrong format for a supplier ID then we introduce exception]. The next section depicts where do we want to expose this property within enterprise application ecosystem. As in, the configs to enable this property in audit log, do we want to add data access controls for this property [as in users with only a specific activity can see value of this field], enable this in reporting system or store the value of this field in an external storage like blob/S3 buckets.

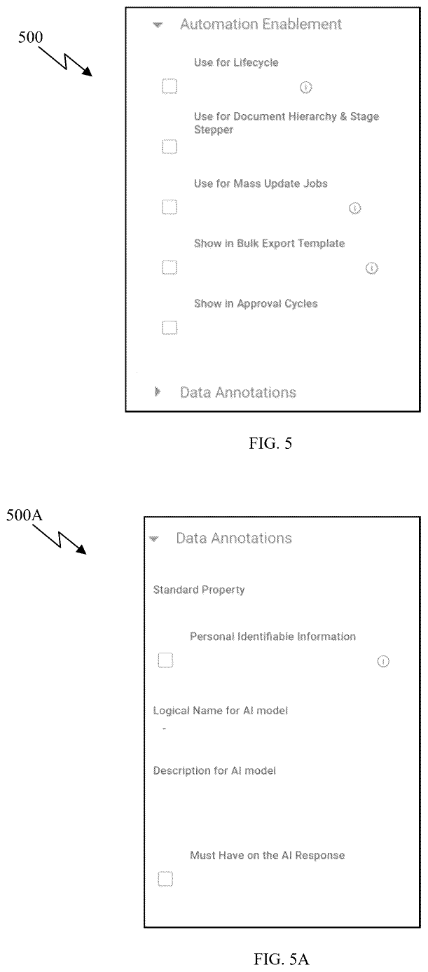

Referring to FIGS. 5, 5A, user interface (500, 500A) of the enterprise application depicting data automation enablement and data annotations of an application object or document is shown in accordance with an example embodiment of the invention. This provides automation enablement to enable/give the capability for the user to expose this property in various flow components within enterprise application. Like do you want this property to be showing up for rules creation or if the property needs to be passed on in the lifecycle of this document. The Data annotations section is to determine how do you want to annotate this property as. Meaning, do you want to annotate this property as a Personally identifiable information (PII) field, then this drive how it is stored [encrypted form] in the actual DB. The invention also determines if it is required to flag this field to be used by internal AI models for any kind of data processing.

The domain entities represent classes of real-world objects. They have properties that identify or describe them. Entity properties also govern their availability and behavior related to the application's visual elements or operational logic. The domain entities may have event handlers which describe the behavior of the entity before/after committing the runtime transaction of a specific entity. The entities are persistable, meaning that they represent a schema in the data service and also non-persistable, meaning that they are used in context of integration, as a reference for example to Master data and are not represented directly with a schema definition in the data service. The domain entities will also be used to define DAC (Data access Control) for users consuming data from a specific application. The entities can be imported and/or exported from a domain model under the form of a canonical structure, or even any JSON structure. The entity properties represent characteristics that identify and/or describe an entity. Each property is of a certain type and can be configured individually. The entity properties can prove useful to application developers in more than one way. End-users could interact with them via forms and inputs for storing or using data. The associated operational logic of the application could also make use or change the data. While other properties will simply account for the domain modeling process itself, or even be auto generated. The entity properties can have validation rules, calculated values (non-persistent), primitive types and/or associations. They can also be marked as indexable for ES in the context of advanced or global search. Each entity also has a set of system fields which are managed internally by the CRUD/Runtime service, entities like Audit, Created_By, Creation_Time, etc.

In an embodiment, associations between entities are critical to effective modeling as without them, the model is just a vocabulary of broad terms since it lacks the collaborative context. They can be used to create more complex structures, by referencing or composing entities.

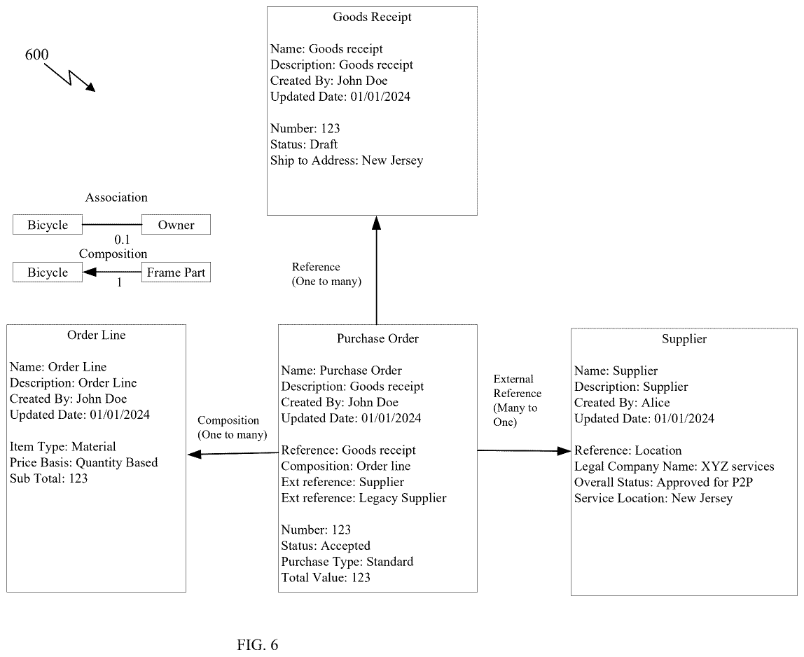

In a related example embodiment, the type of associations include reference where both entities can exist independently and still have operational value like Order and Supplier as shown by diagram 600 of FIG. 6. Also, the association includes composition where a particular type of entity association, modeling a part of a whole relationship between the composite and a group of parts. The items or data records of composed entities are bound, so removing the whole would also delete the parts like Order and Order schedule.

In an embodiment, the structure of the domain model captures operational information and operational rules associated with the elements of the one or more internal application objects. The application objects associated with the Domain Model enables support for spatial data editor (SAGA) and compensation of transaction to avoid orphan metadata.

In an exemplary embodiment, Domain Model has a wrapper to connect to various database types. Object Mapper is responsible to convert domain model to data model as per schema defined. The CRUD (Create, read, update and delete) Operations exposed by Domain Model has operational rules validations, Mandatory check, Defaulting etc. APIs exposed by domain model are mapped to application objects like Form Designer and CRUD operations for transaction.

In a related embodiment, the data patterns are obtained from an application knowledge database such as a graph database. The invention extracts a plurality of relationship categories from the graph database to create a taxonomy of relationships associated with the application data. The database stores real-time application usage data, data about dynamic changes in attributes and related functions of the application.

In an example embodiment, the invention provides an application development scenario with the dynamically changing domain model. The domain model structure of the invention enables creation of application group on developer domain and within this group Customer order and Supplier order is created as modules. Each module has its own set of localizations, CDS, plugins, widgets and domain models. The localization component of the Customer Order module includes localization keys as unique key identifier for each piece of translatable content. For Eg: a key “Submit”. Whenever a localization key (eg, Submit) is added to a module, the actual value (translation) is stored at a global or common level. This design choice ensures that any change in the translation value is reflected across all modules referencing that key to promote consistency. Further, each modification to a translation spawns a new version. For instance, if “Submit” originally translated to “Save” but is later changed to “Save Document”, the newer translation becomes the latest version. While the latest version is typically active (i.e., the one retrieved when the key is referenced), users retain the flexibility to activate any prior version, ensuring control and flexibility. For fetching operation, when a module requires the value of a localization key, it doesn't fetch the value directly from within. Instead, it references the global/common level. The active version of the key at the global level is what gets retrieved, ensuring that all modules consistently present the most up-to-date or designated translations.

In an exemplary embodiment, the domain model enables patching and merging operation in the codeless platform. The domain model records all actions performed by users as patches. These patches can then be used to merge different versions of an application between two environments: the Developer Domain and the Client Domain. This allows for seamless integration of application customizations while retaining necessary updates from the original source.

The Client Domain has a new version of the application metadata that includes First Name with a maxlength of 100 (client customization), Last Name (client-added field), PhoneNumber (developer-added field). The AI bots analyze the application parameters and functions to be executed before identifying precedence where applicable, and new fields from the developer domain are seamlessly integrated.

In an embodiment, the API generating data script is configured to generate one or more API for integrating with the one or more domain model. The API is generated based on the behavior of the attributes on an electronic user interface of the application, the one or more data validation rules and a data pattern associated with operation of the one or more applications.

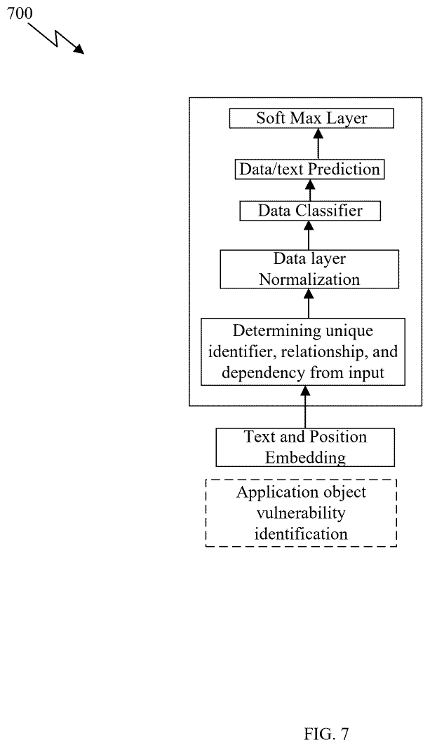

In an embodiment, the application knowledge database includes historical knowledge data and associated unique identifiers related to vulnerabilities triggered in the application due to modification of the application objects. In case the knowledge database is unable to map the element with a unique identifier, the one or more processor is configured to analyze the one or more elements for vulnerability based on LLM (large language model) agents. The processor always the one or more elements based on augmented LLM agents to provide accurate results. The vulnerability determination model flow 700 is shown in FIG. 7 with a SoftMax layer for vulnerability determination in patching and merging method of the invention. To process application object input with models, it is tokenized into a sequence of words associated with the one or more elements of the application objects. These tokens are then encoded as numbers and converted into embeddings, which are vector-space representations of the tokens that preserve their meaning. Next, an encoder transforms the embeddings of all the tokens into a context vector. The context vector allows the domain model to attend to one or more elements of the application object to capture its relationships and dependencies. Using the context vector, the domain model generates output based on the input. The context vector is large so it can handle very complex concepts, and with many layers in its encoder and decoder. The models may be based on deep learning that captures long-range dependencies between words, graphs elements and hence the domain model understands the context to determine vulnerability.

In an embodiment, the AI engine includes a code module configured for generating a plurality of protocols based on the modified application object, a plurality of metadata and data models associated with the modified application object. The protocols are generated for executing the patching and merging operation by the AI engine based on an AI based processing logic, wherein a controller coupled to the AI engine triggers an application UI loading component for conditionally loading at least one module on an application UI based on the vulnerability determination for patching and margining the application objects.

In a related embodiment, one or more functions of the application are recalibrated automatically in real-time once the patching and merging operation is executed. Further, the AI based processing logic includes a sequential, a parallel or switching based processing logic or a combination thereof. The AI based processing logic, integrates deep learning, predictive analysis, information extraction, planning, scheduling, impact analysis and robotics for processing the functions of the enterprise applications based on plurality of machine learning (ML) data models and large language models (LLM) agents.

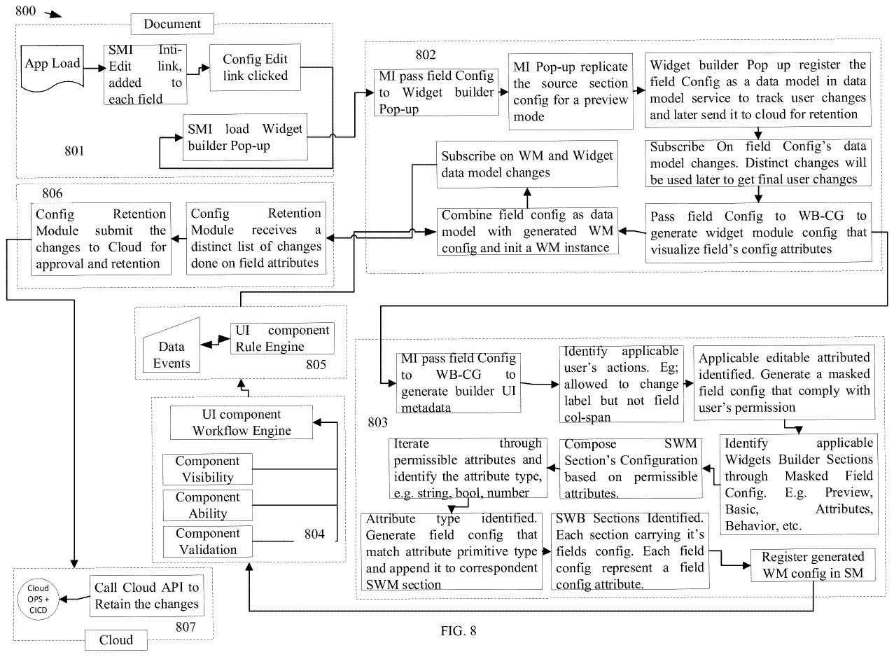

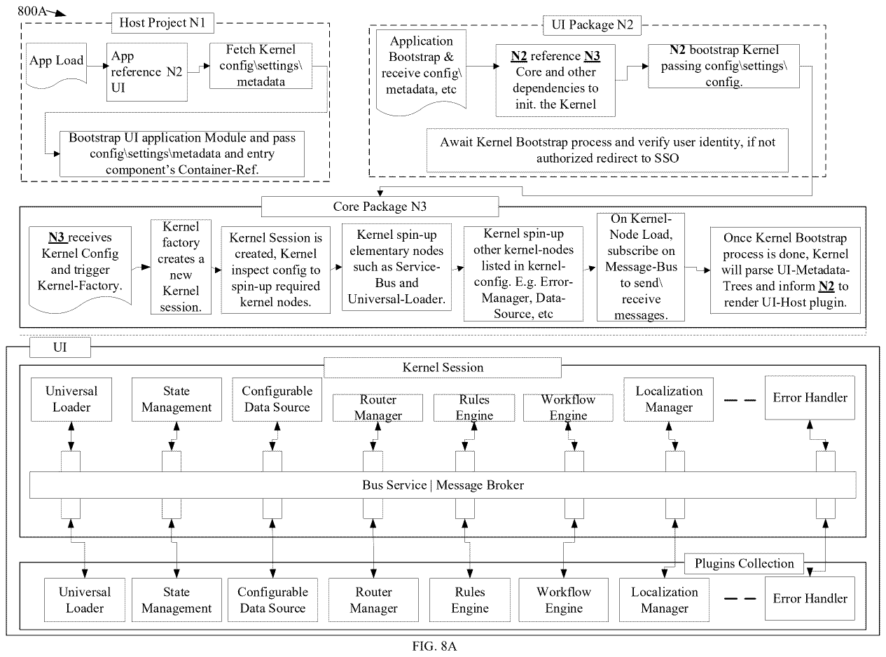

Referring to FIG. 8, a Widget builder platform is provided in accordance with an example embodiment of the invention. The Widget builder is a codeless platform package that allows client user and developer user to build, modify and customize application by modifying the application objects. Through Widget builder platform, users can change the field label, behavior [e.g. width] and attributes [e.g. visibility] as well as adding new widgets and fields and link these fields to external data models. The process flow includes injection of edit link if user\admin are authorized to edit form configuration in 801. When link is clicked MI load popup. In 802 Widgets Builder pass the field to config generation module to generate fields metadata for applicable\authorized attributes. In 803 WB Config Generator produces the metadata for a field and it pass the metadata to a Workflow engine to determine fields visibility. In 804 once workflow engine finalizes the rules, it will pass the metadata to a rules engine to verify field rules. In 805 rules engine finalize the rules check and pass the composed config back to SWB popup and await user changes. In 806 once the user finalizes their changes, WB popup will produce series of changes and send it to retention module. In 807, WB Retention module will submit changes to cloud for approval and then retention and finally for composition and regeneration. [000111]In an embodiment, the metadata includes a Layout Metadata, Workflow metadata, Validation metadata, pluggable packages and modules metadata, application metadata, configurable data source metadata. The Layout metadata describes how a layout of an application will be rendered, using which UI elements. The workflow Metadata describes how UI elements will mutate its state based on the current application status. The Validation Metadata describes that the data model associated with a given UI Element should be validated. The Pluggable Packages & Modules Metadata carries a map of supported JS Modules (DEV/AOT) acting as a local Unpackaged gallery. The application Metadata describes app structure and rules defined by application admin user and it's different from a layout metadata. The Configurable Data Source Metadata describes the applicable data endpoints for a given application or shared across apps.

In an embodiment, the configurable data sources feed of the system is responsible to abstract external data fetch/retention activities and introduce a metadata driven compassable data feed. The source shall be consumed by other core packages or plugins through massaging bus pattern 800A as shown in FIG. 8A. The messaging bus pattern includes node N1 as Host project that reference and invoke node “N2” UI Package. Host Project should NOT contain any logic, it is meant to deliver config\settings\metadata to N2. Node N2 is the UI package meant to combine plugins collection and kernel, also it shall host none-pluggable modules. Node N3 is a core package meant to control\manage low-level activities, such as Service-Bus, Universal-Loader, State-Management, etc. Kernel nodes must not be accessible to plugins\workspace\host instead communications happen through Service-Bus. Feeds receive a predefined massage structure to trigger a Data Source, merge data feeds when needed, message data and inform consumer when data is available, optionally resolved data could be registered in a state management repository for future data manipulation.

In an advantageous aspect, the configurable data source and the system of the present invention enables exposure of easy to use interface and APIs, handling of all data fetch/retention scenarios, accepting/parsing/execution of metadata that represent fetch/retention activities, incorporation of necessary reactive operators e.g to fork-join, concatenate reactive events, querying for a previously registered data source feed and if not expired then serve it from store management, resolution of dependency feeds e.g if Supplier details feed require some data from basic details feed which is not currently loaded, the Configurable data source fetches dependency feeds before triggering the original feed, interception of the fetch/retention activities and appending JWT token required to communicate with API's, application of multiple data manipulations through pluggable data massagers, notifying entities with the stats of their requests by sharing the message status e.g request received fetching, merging, massaging, completed etc. The configurable data source further enables determination of an expiration window for active feeds and refresh the data when feed expires, communication with a store management microkernel node to retain/operate on feeds, monitoring data fetch/retention activities for performance, error handling and statistical information.

In an exemplary embodiment, external APIs are triggered in server side to avoid sending sensitive tokens to front-end [E.g tokens to communicate with other APIs]. The configurable data source implementation enables automation of data fetch/detection activities through metadata, reduction in efforts by eliminating the need of coding to fetch/retain data and enforcement of standards by providing set of unified messages to fetch/transform/mutate/retain data.

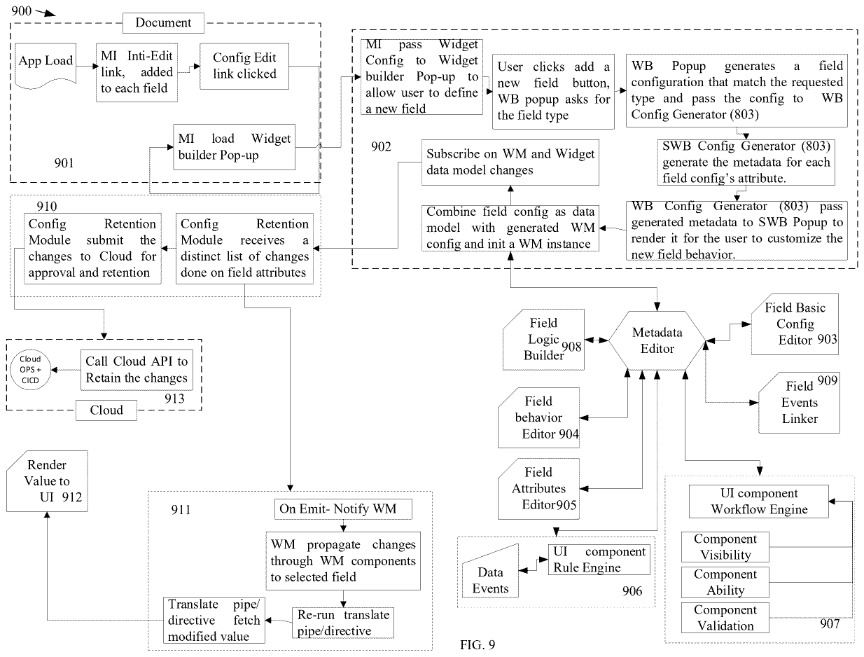

Referring to FIG. 9, in an example embodiment, a widget builder platform with multiple modules and process flow for adding a field on an application UI is provided in accordance with an embodiment of the present invention. The process flow includes injection of edit link if user\admin are authorized to edit form configuration in 901. When link clicked SMI load popup. In 902 Config dispatcher is dividing related config metadata into sections and send the generated metadata to appropriate editor. In 903 basic Config editor is responsible to edit basic configuration such as Id, label, etc. In 904 a behavior editor is responsible to edit field behavior and how it will appear on screen. In 905 attributes Editor is responsible to edit field attributes such as ability and visibility. In 906 a Rules Editor is responsible to define the rules related to new field. In 907 a Workflow Editor is responsible to link generated field with corresponding operational rules. In 908, a Logic builder is where admin could define the operational logic to be executed in certain events. In 909 an events linker links a field event such as change or select to a pre-defined operational logic. In 910 Listen for admin activities and changes on Builder and keep track of changes being done for retention. In 911 when admin finalized all the changes, Config Retention module will notify Widgets Manager to reflect the changes. In 912 widgets Manager propagate the changes through child components and add the new field to the application UI/(DOM). In 913 distinct changes will be submitted to the cloud for composition, regeneration and retention.

In an exemplary embodiment, the changes are incorporated through domain models after vulnerability assessment of the changes submitted to the cloud.

In an exemplary embodiment, the present invention may be a system, a method, and/or a computer program product for data processing in enterprise application. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer /stem/ computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer system can include clients and servers. A client and server are generally remote from each other and typically interact through a network, such as the described one. The relationship of client and server arises by virtue of computer programs running on the respective computers and having a client-server relationship with each other. The client domain user and developer domain user have the ability to modify application objects and thereby managing the workflows.

In addition, the logic flows, node structures and other related structural flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A method for managing one or more dynamically changing domain model of one or more enterprise applications developed by a codeless platform, the method comprises:
receiving one or more attributes of the application configured to modify one or more application;
identifying by an AI engine, characteristics of the one or more attributes associated with the modified one or more application;
creating at least one domain model based on the attribute of the application, characteristics of the attributes, and one or more data validation rules; and
invoking by a bot, an API generating data script configured to auto-generate one or more API for integrating with the one or more domain model wherein the one or more API is generated based on behavior of the attributes on an electronic user interface of the application, the one or more data validation rules and a data pattern associated with operation of the one or more applications,
wherein API is configured to adjust to dynamic changes in the domain model based on the modification of the one or more application developed by the codeless platform.

2. The method of claim 1, further comprises database agnostic storage of attributes and one or more application data object.

3. The method of claim 1, wherein the Codeless platform includes
a plurality of configurable components; a customization layer; an application layer; a shared framework layer; a foundation layer; a data layer; a process orchestrator; and
at least one processor configured to cause the plurality of configurable components to interact with each other in a layered architecture to:
customize the one or more Supply Chain Management (SCM) application based on the at least one modified application object and at least one operation to be executed using the customization layer;
organize at least one application service of the one or more Supply Chain Management (SCM) application with the at least one modified application object by causing the application layer to interact with the customization layer through one or more configurable components of the plurality of configurable components, wherein the application layer is configured to organize the at least one application service of the one or more Supply Chain Management (SCM) application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more supply chain management (SCM) application with the at least one modified application object using a process orchestrator to enable interaction of the plurality of configurable components in the layered architecture.

4. The method of claim 1, wherein the data pattern is obtained from an application Knowledge database configured to store data about dynamic changes in the attributes and related functions of the application.

5. The method of claim 1, wherein the characteristic of the one or more attributes includes mandatory non-mandatory fields, data type of the attribute, length of the attribute, default value, validations, flags to send data to tertiary systems as audit log, reports, availability of the attribute for components like bulk templates, and define annotations of the attribute.

6. The method of claim 4, wherein a processor is configured to generate one or more data models based on the application knowledge database wherein the knowledge database stores real-time application usage data for recommending the attribute.

7. The method of claim 6, further comprises:
processing a historical dataset characteristic data from the knowledge database to predict data attribute characteristic for recommending the attribute based on a dynamic processing logic.

8. The method of claim 7, wherein the dynamic processing logic integrates deep learning, predictive analysis, data extraction, impact analysis, configuration pattern generation and bots for processing the dataset to recommend the attribute.

9. The method of claim 1, wherein a code generated by the bot triggers a rule engine to involve assessment of the attribute based on an attribute rule data script.

10. The method of claim 1, wherein the domain models include one or more annotations configured for enabling a domain model bot to identify characteristic of the dynamically changing domain model.

11. The method of claim 8, wherein the domain model includes one or more application entities with their relationship to other entities represented by association wherein the one or more annotations connected to the domain model enables identification of means by which the domain model is to be operated.

12. The method of claim 11, wherein the domain model includes a wrapper with data structure configured to provide information to a compiler for connecting to a plurality of databases of the one or more enterprise applications.

13. A system for managing one or more dynamically changing domain model of one or more application developed by codeless platform, the system comprises:
one or more processors; and
one or more memory devices including instructions that are executable by the one or more processor for causing the processor to:
receive one or more attributes of the application configured to modify one or more application;
identify characteristic of the one or more attributes associated with the modified one or more application;
create at least one domain model based on the attribute of the application, characteristics of the attributes, and one or more data validation rules; and
invoke by a bot, an API generating data script configured to auto-generate one or more API for integrating with the one or more domain model wherein the one or more API is generated based on behavior of the attributes on an electronic user interface of the application, the one or more data validation rules and a data pattern associated with operation of the one or more applications,
wherein API is configured to adjust to dynamic changes in the domain model based on the modification of the one or more application developed by the codeless platform.

14. The system of claim 13, further comprises database agnostic storage of attributes and one or more application data object.

15. The system of claim 13, wherein the Codeless platform includes:
a plurality of configurable components; a customization layer; an application layer; a shared framework layer; a foundation layer; a data layer; a process orchestrator; and
at least one processor configured to cause the plurality of configurable components to interact with each other in a layered architecture to:
customize the one or more Supply Chain Management (SCM) application based on the at least one modified application object and at least one operation to be executed using the customization layer;
organize at least one application service of the one or more Supply Chain Management (SCM) application with the at least one modified application object by causing the application layer to interact with the customization layer through one or more configurable components of the plurality of configurable components, wherein the application layer is configured to organize the at least one application service of the one or more Supply Chain Management (SCM) application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more supply chain management (SCM) application with the at least one modified application object using a process orchestrator to enable interaction of the plurality of configurable components in the layered architecture.

16. The system of claim 13, wherein the data pattern is obtained from one or more data models related to an application Knowledge database configured to store data about dynamic changes in the attributes and related functions of the application.

17. The system of claim 13, wherein the characteristic of the one or more attributes includes mandatory non-mandatory fields, data type of the attribute, length of the attribute, and default value, validation, flags to send data to tertiary system as audit log, reports, availability of the attribute for components like bulk templates, and define annotations of the attribute.

18. The system of claim 16, wherein a processor is configured to generate the one or more data models based on the application knowledge database by:
retrieving one or more historical application attributes and data object elements from the historical knowledge database;
extracting a plurality of relationship categories from the graph database to create a taxonomy of relationships associated with the application data object elements; and
invoking by the processor, one or more application module operational logic associated with each of the application module of the application based on the application object elements for generating an execution pattern between one or more application data object elements for generating the prediction data model.

19. The system of claim 18, further comprises:
processing a historical dataset characteristic data from the knowledge database to predict data attribute characteristic for recommending the attribute based on a dynamic processing logic.

20. The system of claim 18, wherein the dynamic processing logic integrates deep learning, predictive analysis, data extraction, impact analysis, configuration pattern generation and bots for processing the dataset to recommend the attribute.

21. The system of claim 13, wherein a code generated by the bot triggers a rule engine to involve assessment of the attribute based on an attribute rule data script.

22. The system of claim 13, wherein the domain model includes one or more application entities with their relationship to other entities represented by associations wherein one or more annotations connected to the domain model enables identification of means by which the domain model is to be operated.

23. The system of claim 22, wherein structure of the domain model captures operational information and operational rules associated with the elements of the one or more application objects.

24. The system of claim 13, wherein the codeless development platform includes:
a plurality of configurable components; a customization layer; an application layer; a shared framework layer; a foundation layer; a data layer; a process orchestrator; and
at least one processor configured to cause the plurality of configurable components to interact with each other in a layered architecture to:
customize the one or more Supply Chain Management (SCM) application based on at least one operation to be executed using the customization layer;
organize at least one application service of the one or more Supply Chain Management (SCM) application by causing the application layer to interact with the customization layer through one or more configurable components of the plurality of configurable components, wherein the application layer is configured to organize the at least one application service of the one or more Supply Chain Management (SCM) application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more Supply Chain Management (SCM) application using a process orchestrator to enable interaction of the plurality of configurable components in the layered architecture.

25. A non-transitory computer program product for managing one or more dynamically changing domain model of one or more application developed by codeless platform to operate the one or application of a computing device with memory, the computer program product comprising a non-transitory computer readable storage medium having instructions embodied therewith, the instructions when executed by one or more processors causes the one or more processors to:
receive one or more attributes of the application configured to modify one or more application;
identify characteristic of the one or more attributes associated with the modified one or more application;
create at least one domain model based on the attribute of the application, characteristics of the attributes, and one or more data validation rules; and
invoke by a bot, an API generating data script configured to auto-generate one or more API for integrating with the one or more domain model wherein the one or more API is generated based on behavior of the attributes on an electronic user interface of the application, the one or more data validation rules and a data pattern associated with operation of the one or more applications,
wherein API is configured to adjust to dynamic changes in the domain model based on the modification of the one or more application developed by the codeless platform.

26. The non-transitory computer program product of claim 25, wherein the method is performed in a cloud or cloud-based computing environment.
